(19) United States
(12) Patent Application Publication
(10) Pub. No.: US 2007/0058233 A1
(43) Pub. Date: Mar. 15, 2007

(54) Light scanning unit

(75) Inventors: Hyung-soo Kim, Suwon-si (KR); Gi-sung Park, Suwon-si (KR); Kyung-nam Jang, Suwon-si (KR); Jung-hyuck Cho, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co, Ltd.

(21) Appl. No.: 11/387,930

(22) Filed: Mar. 24, 2006

(30) Foreign Application Priority Data
Sep. 12, 2005 (KR) 2005-0084471

(51) Int. Cl. G02B 26/08

(52) U.S. Cl. 359/207; 359/206

(57) ABSTRACT

A light scanning unit includes a light source, a collimating unit for collimating light emitted from the light source, and a rotatory polygonal mirror for deflecting light radiated from the collimating unit. One sheet of an f-theta lens scans the light deflected by the rotatory polygonal mirror to a plane at a substantially uniform velocity to form an image on the plane and to correct a field curvature aberration in a main scanning direction. The f-theta lens may be a meniscus lens having a convex surface directed toward a deflection plane. A curvature of the f-theta lens in the main scanning direction differs from a curvature in a sub scanning direction. The f-theta lens has an aspherical shape in which a curvature in the sub scanning direction is varied continuously. A ratio of the radius of curvature of a first surface to the radius of curvature of a second surface at an optical axis is approximately at least 1.7.

### CROSS REFERENCE TO RELATED APPLICATION

This application claims the benefit under 35 U.S.C. § 119(a) from Korean Patent Application No. 2005-84471, filed on Sep. 12, 2005, the entire contents of which are hereby incorporated by reference.

### BACKGROUND OF THE INVENTION

1. Field of the Invention

The present invention relates to a light scanning unit. More particularly, the present invention relates to a light scanning unit provided with one sheet of an aspherical f-theta (fθ) lens in which a ratio of a radius of curvature of one surface to a radius of curvature of the other surface is appropriately controlled.

2. Description of the Related Art

One of the most important structural elements in an image forming apparatus, such as a laser printer, is a light scanning unit. The light scanning unit scans laser beams modulated according to video data to be printed onto a photosensitive body to form a latent image. It is important that the laser spot is scanned from the light scanning unit onto a surface of the photosensitive body at a regular speed. Accordingly, the light scanning unit is designed such that a rotation angle (θ) of a deflector is in proportion to a position of the spot to be scanned. For obtaining the above relation, a scanning lens is disposed between the deflector and a plane to be scanned.

The scanning lens is the f-theta lens for correcting the distortion aberration and has the aberration correction characteristic for allowing a rotation angle of a laser beam to be in proportion to an image height on a main scanning plane.

Many inventions related to the f-theta lens having such correction characteristics have been proposed. In the majority of such inventions, the scanning lens consists of two or more spherical lenses. However, Japanese Patent Laid Open Publication No. 62-139520 discloses the light scanning unit in which the aberration correction can be achieved by only one aspherical lens. FIG. 1 and FIG. 2 schematically show a structure of the light scanning unit provided with the aspherical f-theta (fθ) lens of Japanese Patent Laid Open Publication No. 62-139520.

Such a light scanning unit is illustrated in FIG. 1. Referring to the drawing, in the light scanning unit, a laser beam 1 emitted from a light source 10, such as a laser diode, is collimated by a collimating lens 12 and a cylindrical lens 13. The laser beam is deflected in a specific direction by a reflective surface 21a of a rotatory polygonal mirror 21 of a deflector 20. The deflected laser beam is passed through a scanning lens 30 and scanned horizontally onto a surface of a photosensitive drum 40 to form a laser spot T1. The photosensitive drum 40 is rotated at a regular speed for enabling the laser beam to be scanned in a vertical direction.

To correct a field curvature aberration in a main scanning direction (a longitudinal direction of the photosensitive drum in FIG. 1) of a beam at an optional position on the plane (photosensitive drum) to be scanned, the f-theta lens 30 has an aspherical shape in which a shape of a first surface S1 differs from that of a second surface S2. Also, the f-theta lens 30 has a characteristic that a curvature of at least one surface of both surfaces of the lens in the sub-scanning direction is varied regardless of a curvature in the main scanning direction to correct a field curvature aberration in a sub-scanning direction (a rotational direction of the photosensitive drum in FIG. 1).

Unlike a process for manufacturing the conventional spherical lens, the material, such as plastic, has excellent plasticity and should be injection-molded for manufacturing the aspherical lens. However, since a thickness of the center of the aspherical f-theta lens 30 is 15 mm or more, a refractive index of the laser beam passed through a section of the lens having a large thickness is largely changed. therefore, the aspherical f-theta lens may not be regarded as the lens for practical use. Particularly, the plastic shows a tendency to be influenced by the environmental fluctuation.

In order to solve the problems of such asperical lens, U.S. Pat. No. 5,111,219 (corresponding to Korean Patent No. 80528) discloses the f-theta lens consisting of one sheet of the aspherical lens and having a thin thickness and being able to be easily manufactured through the injection-molding process. The above f-theta lens is shown in FIG. 3 and FIG. 4.

In the f-theta lenses 31 and 32 of U.S. Pat. No. 5,111,219, a shape of the first curved surface S1, which is adjacent to the deflection point in the main scanning plane, is an aspherical shape. Particularly, near the optical axis, the f-theta lens has an aspherical surface, in at least the main scanning plane. The aspherical shape is convex toward the deflection point. Also, in the f-theta lens, when the radius of curvature of the convex shape near the optical axis in the main scanning plane is r1 and the focal length of the f-theta lens near the optical axis in the main scanning plane is fm, 0≦r1<|fm|. When the point of intersection between the lens surface adjacent to the deflection point is the origin and with the coordinate system of the x-axis plotted in the direction of the optical axis and the coordinate system of the y-axis plotted in the main scanning plane perpendicularly thereto, the f-theta lens is characterized in that the surface shape in the main scanning plane is expressed as a function of S1(y) in which y is a variable. When the maximum effective diameter of the surface in the main scanning plane is Yₘₐₓ, S1 (y) is defined between 0 and Yₘₐₓ, and when r1<Yₘₐₓ, −1<S1(r1)/r1<0.5, and when r1≦Yₘₐₓ, −1XYₘₐₓ/r1<S1 (Yₘₐₓ)/Yₘₐₓ<0.5XYₘₐₓ/r1.

As shown in the drawings, however, in the f-theta lenses 31 and 32, a ratio r2/r1 of the radius r2 of curvature of the second surface S2 to the radius r1 of curvature of the first surface S1 of the f-theta lens on the optical axis is small. Therefore, although a thickness of a center is relatively thin, a ratio of the thickness of the center to the thickness of edge of the lens is small, and so the injection molding process for manufacturing the lens is not performed smoothly.

Accordingly, a need exists for an light scanning unit having an improved f-theta lens that may be easily manufactured.

### SUMMARY OF THE INVENTION

An object of the present invention to provide the light scanning unit in which one sheet of an f-theta lens has a ratio of the radius of curvature of the second surface to the radius of curvature of the first surface that is relatively large and an edge thickness that is relatively thick within the range of thickness of the center, thereby facilitating a lens that may be manufactured easily by an injection molding process.

A light scanning unit according to the present invention includes a light source, a collimating unit for collimating light emitted from the light source, and a rotatory polygonal mirror for deflecting light radiated from the collimating unit. One sheet of an f-theta lens scans the light deflected by the rotatory polygonal mirror to a plane to be scanned at the uniform velocity to form an image on the plane and correcting a field curvature aberration in the main scanning direction. The f-theta lens is a meniscus lens having a convex surface directed toward the deflection plane. A curvature of the f-theta lens in the main scanning direction differs from a curvature in a sub scanning direction. The f-theta lens has an aspherical shape in which a curvature in the sub scanning direction is varied continuously. A ratio of the radius of curvature of a first surface to the radius of curvature of the second surface at an optical axis is at least approximately 1.7.

In an exemplary embodiment of the present invention, a ratio ET/CT of a thickness (CT) of the center to a thickness (ET) of edge section of the f-theta lens at the optical axis is at least approximately 0.7.

An edge thickness of the f-theta lens is relatively thick within the range of thickness of the center, such that the lens of an exemplary embodiment of the present invention may be manufactured easily by the injection molding process using a plastic material. The light radiated from the collimating unit may be parallel light.

In an exemplary implementation of the present invention, the f-theta lens satisfies the conditions that a ratio (CT/L) of a size (L) of the plane to be scanned in the main scanning direction to a thickness (CT) of the center at the optical axis is within the range of 0<CT/L<0.08.

In an exemplary implementation of the present invention, the f-theta lens satisfies the conditions that a ratio (CT/g) of a distance (g) between a deflection surface of the rotatory polygonal mirror and the plane to be scanned to a thickness (CT) of the center at the optical axis is within a range of 0<CT/g<0.15.

The light radiated from the collimating unit may be convergent light or divergent light.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above aspects and features of the present invention will be more apparent by describing exemplary embodiments of the present invention with reference to the accompanying drawings, in which:

FIG. 1 is a perspective view of the light scanning unit provided with the conventional aspherical f-theta (fθ) lens;

FIG. 2 is a schematic view showing a traveling path of light in the light scanning unit of FIG. 1;

FIG. 3 is a schematic view of the aspherical f-theta (fθ) lens in another conventional light scanning unit;

FIG. 4 is a schematic view of another conventional aspherical f-theta (fθ) lens;

FIG. 5 is a schematic view of a light scanning unit according to an exemplary embodiment of the present invention;

FIG. 6 is a schematic view of a traveling path of light in the f-theta (fθ) lens according to an exemplary embodiment of the present invention;

FIG. 7 and FIG. 8 are graphs of the performance of the f-theta (fθ) lens according to an exemplary embodiment of the present invention;

FIG. 9 is a schematic view of a traveling path of light in the f-theta (fθ) lens according to another exemplary embodiment of the present invention; and

FIG. 10 and FIG. 11 are graphs of the performance of the f-theta (fθ) lens according to another exemplary embodiment of the present invention.

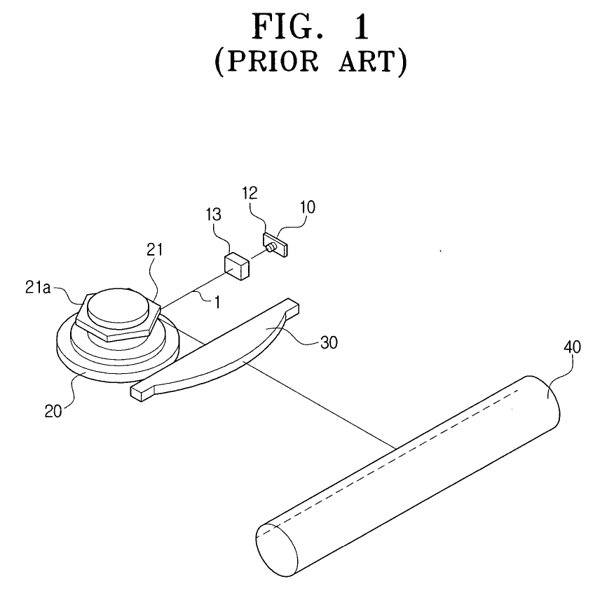

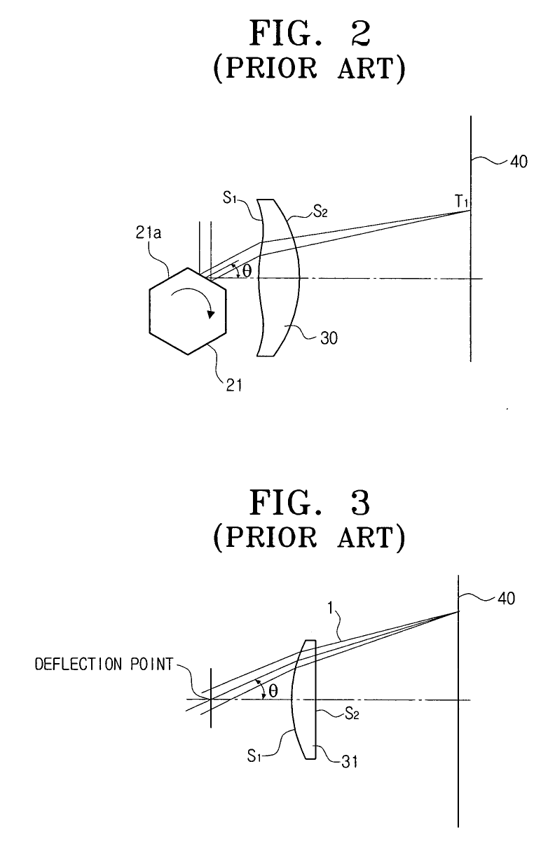

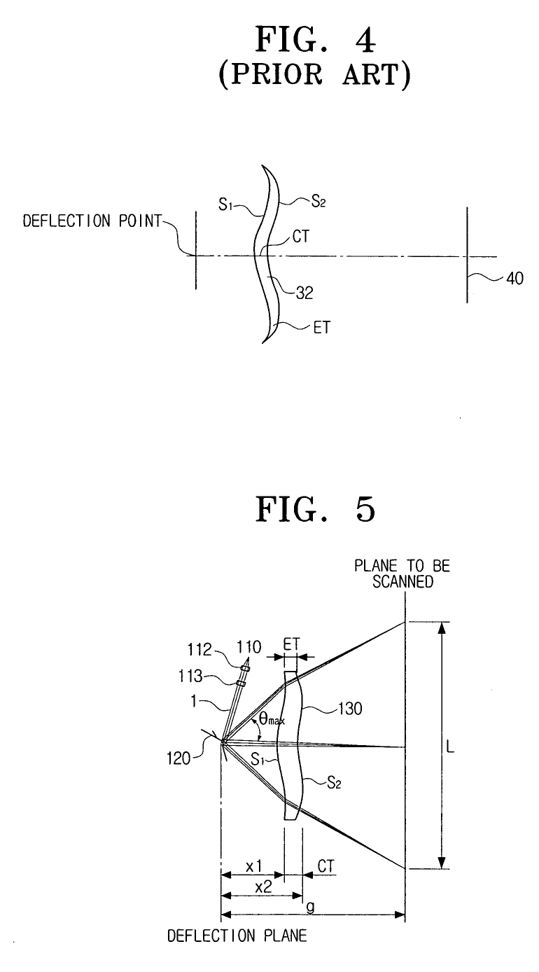

Throughout the drawings, like reference numerals will be understood to refer to like parts, components and structures.

### DETAILED DESCRIPTION OF EXEMPLARY EMBODIMENTS

Hereinafter, the light scanning unit according to exemplary embodiments of the present invention is described in detail with reference to accompanying drawings.

FIG. 5 is a schematic view of a structure of a light scanning unit according to an exemplary embodiment of the present invention. In FIG. 5, “x1” is a distance (mm) between a deflection plane and a first surface S1 of the scanning lens, and “x2” is a distance (mm) between the deflection plane and a second surface S2. “θₘₐₓ” indicates a maximum effective scanning angle (°) of the deflected laser beam 1. “CT” indicates a thickness (mm) of a central portion of the lens on the optical axis. “ET” indicates a thickness (mm) of an edge of the lens in a main scanning plane at the maximum effective scanning angle. Also, “g” is a distance (mm) between the deflection plane and a plane to be scanned. “L” is a size of the plane to be scanned in a main scanning direction, that is, a distance (mm) between the laser spots to be scanned at the maximum effective scanning angle.

Referring to the drawings, the light scanning unit according to an exemplary embodiment the present invention includes a light source 110, a collimating unit 112, a rotatory polygonal mirror 120 and a scanning f-theta lens 130.

The light source 110 may have a light emitting diode (LED) or a semiconductor laser diode (LD). The collimating unit 112 is used for collimating light emitted from the light source 110. Typically, the collimating unit 112 is provided with the collimating lens. The rotatory polygonal mirror 120 deflects light 1 radiated from the collimating unit 112 in the main scanning direction. A cylindrical lens 113 may be disposed between the collimating unit 112 and the rotatory polygonal mirror 120 for radiating the laser beam as sheet light. The light source 110, the collimating unit 112 and the rotatory polygonal mirror 120 are substantially similar to those of conventional light scanning units, and a detailed description thereon is omitted.

The f-theta lens 130 is the scanning lens. The f-theta lens is a single lens having an aspherical shape. A sectional shape of this aspherical f-theta lens in the main scanning plane is determined as follows.

When the direction of the optical axis is regarded as the x-axis, the direction in the main scanning plane that is perpendicular to the direction of the optical axis is regarded as the y-axis and the point of intersection between the lens surface and the optical axis is defined as the origin, a sectional shape of the aspherical lens may be expressed in the form of the polynomial expression of Equation 1, including the higher order terms.

$$S ( h ) = \frac{{h}^{2} / R}{1 + \sqrt{1 - ( 1 + K ) {h}^{2} / {R}^{2}}} + A {h}^{4} + {Bh}^{6} + {Ch}^{8} + {Dh}^{10} \qquad [ Equation 1 ]$$

Wherein, “h” is a height from the optical axis in the vertical direction, “S(h)” means the amount of SAG, which is a distance between one point of the asperical surface at the height “h” from the optical axis and a plane that is tangent to the asperical surface at the optical axis. “R” is a radius of curvature of the lens surface in the main scanning plane at the optical axis. “K”, “A”, “B”, “C”, “D” are the aspherical coefficients.

The f-theta lens 130 is the lens for forming an image on the plane to be scanned at a substantially uniform velocity and correcting the field curvature aberration in the main scanning direction. This lens may, for example, be a meniscus lens having a convex surface directed toward the deflection plane. Also, the f-theta lens 130 has the aspherical shape in which a curvature in the main scanning direction differs from a curvature in the sub scanning direction and a curvature in the sub scanning direction is varied continuously. In the f-theta lens 130 of an exemplary embodiment of the present invention, a ratio r2/r1 of the radius of curvature r1 of the first surface S1 to the radius of curvature r2 of the second surface S2 at the optical axis is at least approximately 1.7.

In the f-theta lens 130, it is preferable that a ratio ET/CT of a thickness (CT) of the center of the lens to a thickness (ET) of the edge at the optical axis exceeds approximately 0.7. A thickness of the edge of the f-theta lens 130 is relatively thick within the range of thickness of the center, such that the lens may be manufactured easily by an injection-molding process when plastic is used for making the lens. When a ratio ET/CT of a thickness (CT) of the center of the lens to a thickness (ET) of edge section at the optical axis exceeds approximately 0.7, parallel light may be used as light emitted from the light source 110.

According to an exemplary implementation, in the f-theta lens 130, a ratio CT/L of a size L of the plane to be scanned in the main scanning direction to a thickness CT of the center portion at the optical axis is within a range of 0<CT/L<0.08, and a ratio CT/g of a distance g between a deflection surface of the rotatory polygonal mirror 120 and the plane to be scanned to a thickness CT of the center at the optical axis is within a range of 0<CT/g<0.15.

Hereinafter, exemplary embodiments of the present invention will be described in detail with reference to accompanying drawings.

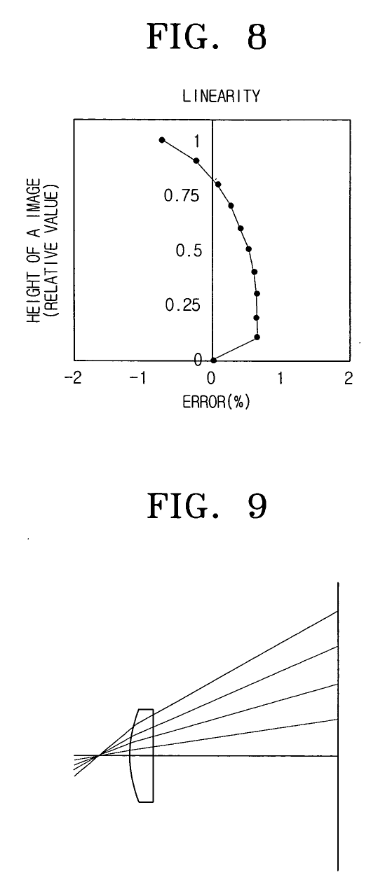

In a first exemplary embodiment of the present invention, the f-theta lens as illustrated in the Table 1 was designed pursuant to Equation 1 and mounted to the light scanning unit. The experimental results are shown in FIG. 7 and FIG. 8.

In Table 1, “n” is a refractive index. “x1” is a distance (mm) between the deflection surface to the first surface of the lens. “x2” is a distance (mm) between the deflection surface to the second surface of the lens. θₘₐₓ is the maximum effective scanning angle. “CT” is a thickness (mm) of the center of the lens at the optical axis. “ET” is a thickness (mm) of the edge of the lens at the optical axis in the main scanning plane.

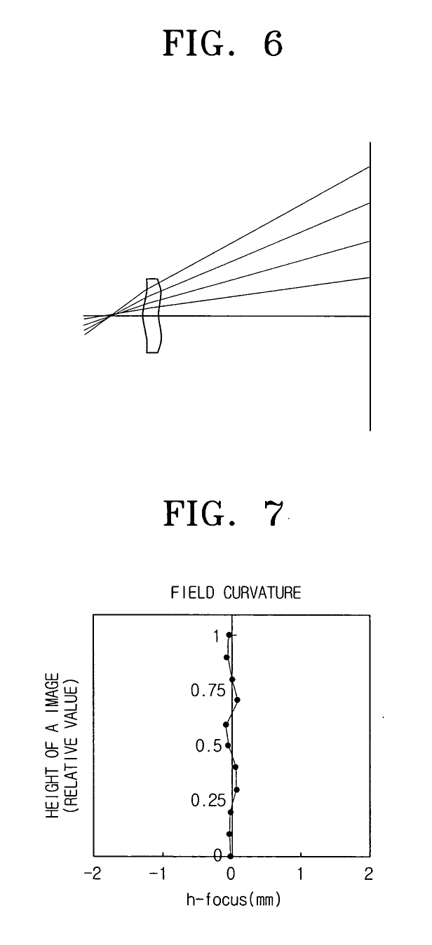

In FIG. 6, the f-theta lens according to the first exemplary embodiment designed under the conditions in Table 1 is illustrated.

TABLE 1

| Design value of | | |
|---|---|---|
| Lens | First Surface (S1) | Second Surface (S2) |
| r | 42.27390 | 83.65851 |
| K | 0 | 0 |
| A | −0.280318E−04 | −0.179566E−04 |
| B | 0.376234E−07 | 0.159109E−07 |
| C | −0.307131E−10 | −0.420463E−11 |
| D | −0.197086E−13 | −0.155207E−13 |
| N | 1.486 | |
| θₘₐₓ | 35° | |
| CT | 8.4715 mm | |
| ET | 6.594 mm | |
| x1 | 24.444734 mm | |
| x2 | 32.916267 mm | |
| L | 198.5802 mm | |
| g | 186.9401 mm | |

In the f-theta lens of the first exemplary embodiment, as known from Table 1, the ratio r2/r1 of a radius of curvature of the first surface to a radius of curvature of the second surface is 1.98, a ratio ET/CT of a thickness of the center of the lens to a thickness of the edge is 0.778, a ratio CT/L of a size of the plane to be scanned in the main scanning direction to a thickness of the center at the optical axis is 0.04, and a ratio CT/g of a distance between a deflection surface and the plane to be scanned to a thickness of the center at the optical axis is 0.05. The above conditions satisfy the optimum conditions in the first exemplary embodiment of the present invention.

FIG. 7 and FIG. 8 are graphs showing the performance of the f-theta lens according to the first exemplary embodiment of the present invention. FIG. 7 is a graph showing the field curvature aberration of the f-theta lens according to a height of an image in the main scanning plane. FIG. 8 is a graph showing the linearity of the f-theta lens of the first exemplary embodiment according to a rotation angle of the rotatory polygonal mirror and a height of an image. As shown in the drawings, the f-theta lens according to the first exemplary embodiment has the excellent f-theta characteristics in which a range of the field curvature aberration is within ±1% and the linearity error is approximately 1% or less.

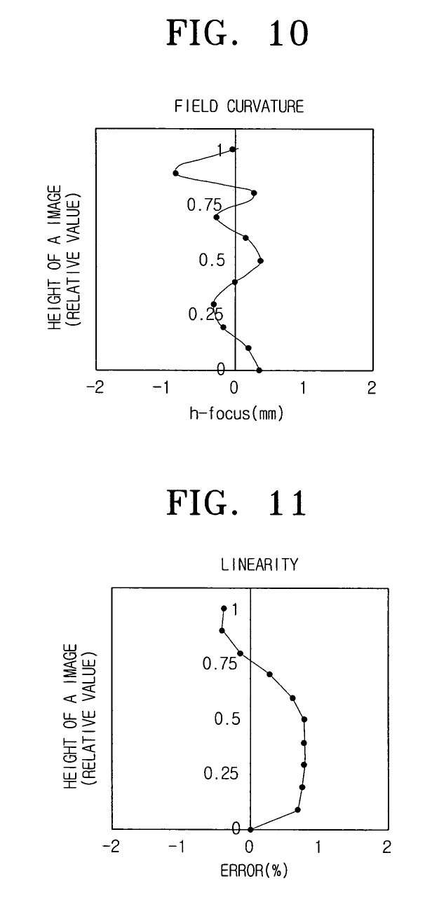

Similar to the first exemplary embodiment, the f-theta lens as illustrated in Table 2 was designed pursuant to Equation 1 and mounted to the light scanning unit. The experimental results are shown in FIG. 10 and FIG. 11. In FIG. 9, the f-theta lens according to a second exemplary embodiment is designed pursuant to conditions illustrated in Table 2.

TABLE 2

| Design value | | |
|---|---|---|
| of Lens | First Surface (S1) | Second Surface (S2) |
| R | 39.52776 | 75.50864 |
| K | 0 | 0 |
| A | −0.200086E−04 | −0.978525E−05 |
| B | 0.131023E−07 | 0.147268E−08 |
| C | 0.862640E−11 | 0.625565E−11 |
| D | −0.116312E−13 | −0.226350E−14 |
| n | 1.486 | |
| θₘₐₓ | 38° | |
| CT | 13 mm | |
| ET | 10.95 mm | |
| x1 | 39.52776 mm | |
| x2 | 52.52776 mm | |
| L | 199.8657 mm | |
| G | 188.3784 mm | |

In the f-theta lens of the second exemplary embodiment, as known from Table 2, the ratio r2/r1 is 1.91, a ratio ET/CT is 0.842, a ratio CT/L is 0.07 and a ratio CT/g is 0.07. The above conditions satisfy the optimum conditions in an exemplary implementation of the present invention.

FIG. 10 and FIG. 11 are graphs showing a performance of the f-theta (fθ) lens according to the second exemplary embodiment of the present invention. FIG. 10 is a graph showing the field curvature aberration of the f-theta lens according to a height of an image in the main scanning plane. FIG. 11 is a graph showing the linearity of the f-theta lens of another exemplary embodiment according to a rotation angle of the rotatory polygonal mirror and a height of an image. Referring to the drawings, similar to the first exemplary embodiment, the f-theta lens according to the second exemplary embodiment has the excellent f-theta characteristics in which a range of the field curvature aberration is within ±1% and the linearity error is approximately 1% or less.

As described above, according to the f-theta lens according to exemplary embodiments of the present invention, a ratio of a radius of curvature of the second surface to a radius of curvature of the first surface is relatively large and an edge thickness is relatively thick within the range of the thickness of the center, thereby facilitating easier manufacturing of the lens of the exemplary embodiments of the present invention by an injection molding process.

Also, according to the light scanning unit of exemplary embodiments of the present invention, although only one sheet of the f-theta lens is provided, the deflected light radiated from the rotatory polygonal mirror is scanned to the plane at the uniform velocity to form the image of the plane and the field curvature aberration in the main scanning direction may be corrected within an error range, and so an image quality of the image forming apparatus may be enhanced.

The foregoing embodiments and advantages are merely exemplary and are not to be construed as limiting the present invention. The present teaching may be readily applied to other types of exemplary embodiments. Also, the description of the exemplary embodiments of the present invention is intended to be illustrative, and not to limit the scope of the claims, and many alternatives, modifications, and variations will be apparent to those skilled in the art.

What is claimed is:

1. A light scanning unit, comprising:
a light source;
a collimating unit for collimating light emitted from the light source;
a rotatory polygonal mirror for deflecting light radiated from the collimating unit; and
at least one sheet of an f-theta lens for scanning the light deflected by the rotatory polygonal mirror to a plane to be scanned at a substantially uniform velocity to form an image on the plane, and for correcting a field curvature aberration in a main scanning direction,
wherein the f-theta lens is a meniscus lens having a convex surface directed toward a deflection plane, a curvature of the f-theta lens in the main scanning direction differs from a curvature in a sub scanning direction, the f-theta lens has an aspherical shape in which a curvature in the sub scanning direction is varied, and a ratio of the radius of curvature of a first surface to the radius of curvature of a second surface at an optical axis is approximately at least 1.7.

2. The light scanning unit according to claim 1, wherein
a ratio ET/CT of a thickness of the center (CT) to a thickness of an edge section (ET) of the f-theta lens at the optical axis exceeds approximately 0.7.

3. The light scanning unit according to claim 2, wherein
the light radiated from the collimating unit is substantially parallel light.

4. The light scanning unit according to claim 1, wherein
a ratio (CT/L) of a size (L) of the plane to be scanned in the main scanning direction to a thickness of a center of the f-theta lens (CT) at the optical axis is 0<CT/L<0.08.

5. The light scanning unit according to claim 1, wherein
a ratio (CT/g) of a distance (g) between a deflection surface of the rotatory polygonal mirror and the plane to be scanned to a thickness of a center of the f-theta lens (CT) at the optical axis is 0<CT/g<0.15.

6. The light scanning unit according to claim 1, wherein
the light radiated from the collimating unit is convergent light.

7. The light scanning unit according to claim 1, wherein
the light radiated from the collimating unit is divergent light.

8. The light scanning unit according to claim 1, wherein
a cylindrical lens is disposed between the collimating unit and the rotatory polygonal mirror to radiate the light as sheet light.

9. The light scanning unit according to claim 1, wherein
the f-theta lens is manufactured by an injection molding process.

10. The light scanning unit according to claim 1, wherein
the curvature of the at least one f-theta lens is varied continuously in the sub-scanning direction.

11. A light scanning unit, comprising:
a light source;
a collimating unit for collimating light emitted from the light source;
a rotatory polygonal mirror for deflecting light radiated from the collimating unit; and
at least one sheet of an f-theta lens for scanning the light deflected by the rotatory polygonal mirror to a plane to be scanned at a substantially uniform velocity to form an image on the plane and for correcting a field curvature aberration in a main scanning direction,
wherein the f-theta lens is a meniscus lens having a convex surface directed toward a deflection plane, a curvature of the f-theta lens in the main scanning direction differs from a curvature in a sub scanning direction, and the f-theta lens has an aspherical shape in which a curvature in the sub scanning direction is varied.

12. The light scanning unit according to claim 11, wherein
a cylindrical lens is disposed between the collimating unit and the rotatory polygonal mirror to radiate the light as sheet light.

13. The light scanning unit according to claim 12, wherein
a ratio of the radius of curvature of a first surface to the radius of curvature of a second surface at an optical axis is approximately at least 1.7.

14. The light scanning unit according to claim 12, wherein
a ratio ET/CT of a thickness of the center (CT) to a thickness of an edge section (ET) of the f-theta lens at the optical axis exceeds approximately 0.7.

15. The light scanning unit according to claim 14, wherein
the light radiated from the collimating unit is substantially parallel light.

16. The light scanning unit according to claim 12, wherein
a ratio (CT/L) of a size (L) of the plane to be scanned in the main scanning direction to a thickness of a center of the f-theta lens (CT) at the optical axis is 0<CT/L<0.08.

17. The light scanning unit according to claim 12, wherein
a ratio (CT/g) of a distance (g) between a deflection surface of the rotatory polygonal mirror and the plane to be scanned to a thickness of a center of the f-theta lens (CT) at the optical axis is 0<CT/g<0.15.

18. The light scanning unit according to claim 12, wherein
the light radiated from the collimating unit is convergent or divergent light.

19. The light scanning unit according to claim 11, wherein
the curvature in the sub-scanning direction of the f-theta lens is varied continuously.

20. The light scanning unit according to claim 12, wherein
the f-theta lens is manufactured by an injection molding process.
